(19) United States
(12) Patent Application Publication
(10) Pub. No.: US 2016/0357933 A1
(43) Pub. Date: Dec. 8, 2016

(54) COMPUTERIZED MEMBER HEALTH INDICATOR SYSTEM AND METHOD

(71) Applicant: Humana Inc., Louisville, KY (US)

(72) Inventors: Keith Glassford, San Diego, CA (US); Kelly McDonald, Louisville, KY (US); Sandy Chiu, Louisville, KY (US)

(21) Appl. No.: 14/619,931

(22) Filed: Feb. 11, 2015

Related U.S. Application Data
(60) Provisional application No. 61/938,403, filed on Feb. 11, 2014.

(51) Int. Cl. G06F 19/00

(52) U.S. Cl. CPC G06F 19/3431; G06F 19/3418

(57) ABSTRACT

A system and method for determining a health indicator score for a member using public data and private health data. The disclosed system and method is capable of determining a health score for a member of a health plan before private health data is available. The score may be recomputed over time based on additional public and private measures. The accuracy of the score may increase as the member's private health data is obtained and used in the score computation.

### CROSS-REFERENCE TO RELATED APPLICATION

This application claims priority to provisional application 61/938,403 filed on Feb. 11, 2014 and is incorporated by reference in its entirety as if fully recited herein.

### TECHNICAL FIELD

Exemplary embodiments of the present invention relate generally to a computerized method of determining a rating indicator of member health.

### BACKGROUND AND SUMMARY OF THE INVENTION

Healthcare providers, insurance providers, and various governmental agencies tasked with monitoring, maintaining, and improving the health of populations require information about the health of individuals that comprise the population. As a result, healthcare providers, insurance providers, as well as governmental and other agencies gather various pieces of health as well as environmental and other information in order to estimate the health of groups based on the health of individuals. Governmental agencies often track the health of groups based on identifiable characteristics of the group. Such tracking may be based on the reported health of individuals, sorted by geography and demographics such as income and education. Because this information is aggregated by group, without more, the information is not useful to determine the likely health status of an individual member of the group.

In addition to the information available from government agencies, information pertaining to behaviors such as smoking, eating habits, propensity to exercise, and financial information both at the regional and individual level is available from commercial (non-governmental) sources. Health care and health insurance providers may also maintain data at the individual level related to participation in health programs. Examples might include, but are not limited to, exercise, general health and wellness, weight loss, and smoking cessation programs. In addition to information regarding health programs, health care providers and health insurance providers may have access to health records and interaction between providers and individual regarding past and current health complaints and diagnoses. However, the data available from these various sources has the common characteristic of having taken place in the past.

There is a need for system and method of calculating an indication of an individual's current health condition using these data sources. In an embodiment of the invention, a computerized system and method may retrieve information from governmental, commercial, and health data providers as well as health insurance providers and determine a health indicator score using the retrieved information. Embodiments of the invention may also use governmental, commercial, and generic health care and insurance data to estimate the health of an individual when little health record and interaction data is available concerning the individual. Information may be lacking for individuals that are new to a health or insurance provider. Such embodiments may make adjustments to the determined health score as additional health records and interaction records become available. Embodiments of the invention may also be configured to enable a user to compare the health indicator score to other individuals and groups of individuals according to selectable characteristics. An example of such a characteristic may include, but is not limited to, a geographic region.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a block diagram illustrating an embodiment of the invention comprising data inputs, a processor, and a user interface;

FIG. 2 is a graph illustrating the declining incremental utility of medical treatment spending in embodiments of the invention;

FIG. 3 is a chart illustrating a method of determining a member's likely behavioral health characteristics from past medical data;

FIG. 4 is an illustration of a determined member health indicator score moving from an estimated score to an improved or actual score as member data is obtained;

FIG. 5 is a chart illustrating an example of increasing levels of data accuracy that may be obtained from various sources of data with regard to a member characteristic;

FIG. 6 is an example embodiment of a user interface used in the invention to communicate a determined health indicator score;

FIG. 7 is an example embodiment of a user interface used in an embodiment of the invention to facilitate the comparison of a member's health indicator score with scores in a geographic region;

FIG. 8 is an example embodiment of a user interface used in an embodiment of the invention to facilitate the comparison of member health indicator scores from different geographic regions.

### DETAILED DESCRIPTION OF EXEMPLARY EMBODIMENT(S)

Various embodiments of the present invention are described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

As used herein, the term “member” represents an individual who is enrolled in a health insurance plan. One of ordinary skill in the art will realize that “member” could be interchanged with other terms such as patient, resident, etc., depending upon the perspective of the person or organization referring to that individual. As such, application of the inventive concept should not be limited solely to those enrolled in health insurance plans but rather, may be applied to individuals receiving or who may receive medical care from a care provider.

Exemplary embodiments of the present invention are directed to a member-specific health indicator for all members of a health plan, regardless of tenure in the health plan, that may be tracked over time and provides a consistent measure of the health for each of a plurality of members, enabling a shared understanding across all health plan and health care functions. Other embodiments of the invention may be directed to a health indicator for members of a defined population group where the health indicator may be tracked over time to evaluate the health risks to members of the group.

In some embodiments of the invention, a member specific health indicator score may be formed using member data comprised from health record data, member data comprised from self reporting of the member's perceived health condition, commercially available data that may be applied to members, and community characteristics data. Such data may be referred to as private health data or private health measures to indicate that such information is protected and not generally available to the public. Conversely, data that is publicly available, including available by subscription or other means, may be referred to as public data or public measures. Public measures may also include, but are not limited to, data gathered by governmental and commercial entities organized by one or more geographic parameters, age, sex, etc. Such public measures may be referred to as community measures. Such public measures may searched using a member's personal or demographic data such as age, sex, or address.

### Member Data

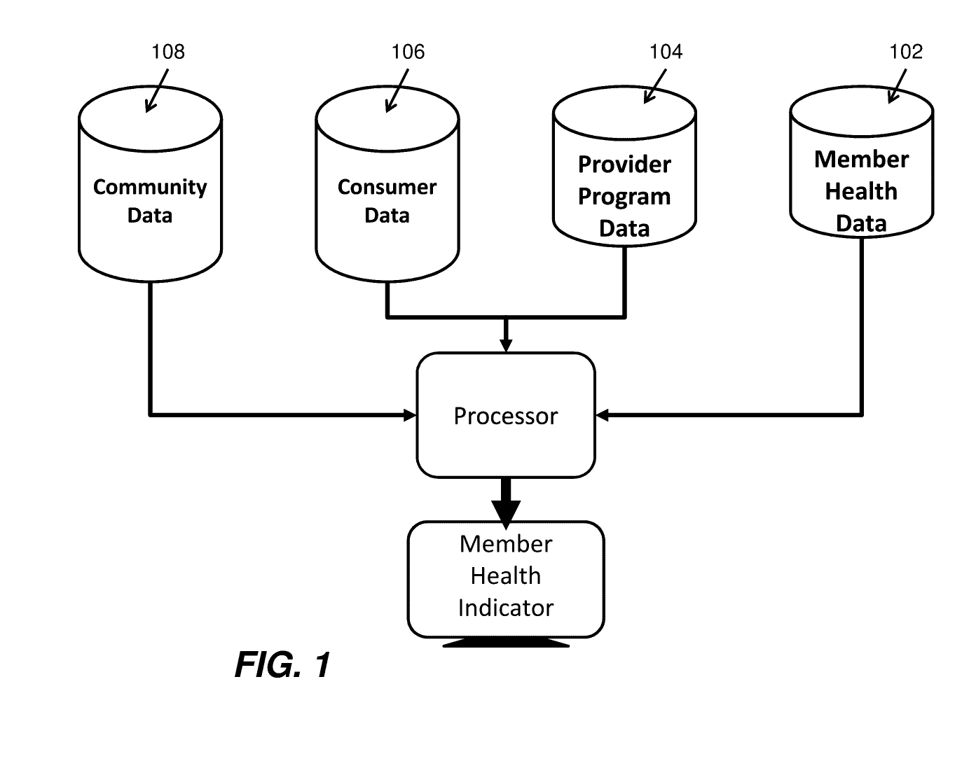

Referring to FIG. 1, available member health data may be organized in subcategories. The first subcategory is data that may be obtained as the result of providing health care to, and processing healthcare claims on behalf of, the member 102. These claims may include data related to health conditions of the member. Examples of such information may be, but are not limited to, inpatient care days, emergency care visits, outpatient care days, tobacco use, alcohol use, diagnoses of chronic or acute illness, comorbidity (concurrent health conditions), member behavioral health, clinical health programs (such as, but not limited to, diabetes management, and chronic care), prescribed medications, compliance with treatment plans and prescriptions, and applied hierarchical condition categories. Another subcategory of member health data may be membership or involvement in programs designed to assist a member in the management of their health 104. Examples of such programs include, but are not limited to, exercise programs, member educational programs, and behavior modification (for example, smoking cessation efforts). Participation in these types of programs may indicate a desire by a member to manage or improve their health.

A third subcategory is self-condition reporting data. This data may be comprised of survey results obtained directly from members. These survey results may be obtained from sources such as member interviews performed by an insurance provider, or as part of a patient intake interview performed by a care provider when providing care for a patient. Such survey results may comprise information obtained from survey sources such as the Vulnerability Elder Survey (VES), the Patient Health Questionnaire (PHQ2), the Health and Wellbeing Index® (a trademark of and administered by Humana, Inc. Louisville, Ky.).

### Commercial Data

Consumer data collected by commercial data analytics firms (commercial data) 106 is that data that may be obtained from sources outside an insurance company or health care provider. Commercial data may be available from various private data analysis firms and is used commercially for such purposes as identifying consumer purchasing activities and preferences. Commercial data may be used to infer certain member behavior. Examples may be tobacco and alcohol use, approaches to dieting and exercise, tendencies toward healthy beliefs or lifestyles, estimated household income, household composition, shopping habits, food preferences, and leisure activities.

### Community Data

Community data is that data that is gathered with respect to a geographic area or region 108. Community data used by embodiments of the invention is generally data that correlates to the general health of the population of an area or region. Community health data is available from various sources including government and private sources. An example of such a source is the Robert Wood Johnson Foundation (RWJF) (Robert Wood Johnson Foundation, Princeton N.J.). The RWJF produces a study entitled “The County Health Rankings and Roadmaps study.” This study is generally updated annually and is focused on vital health factors to provide a snapshot of the health of communities across the country. The focus of this annual study is to provide governments, communities, and policy makers guidance and tools to develop strategies to be used by communities to take action to improve the health of their populations. This annual study provides a ranking of each community organized by Federal Information Processing Standard (FIPS) code within a state for Health Factors and Health Outcomes. Community data sources may rank geographic areas using inputs such as physical environment, socio-economic factors, availability of clinical care, and typical health behaviors. An example of physical environment factor may be environmental quality. Socio-economic factors may comprise education levels, employment levels, income, availability of family and social support, and community safety. Availability of clinical care may take into account both the access to care and the quality of care provided in the region being ranked. Health behaviors look to the propensity of residents of a region with regard to factors affecting health outcomes such as, but not limited to, tobacco and alcohol use, sexual activity, diet, and exercise.

### Consumption of Healthcare Services

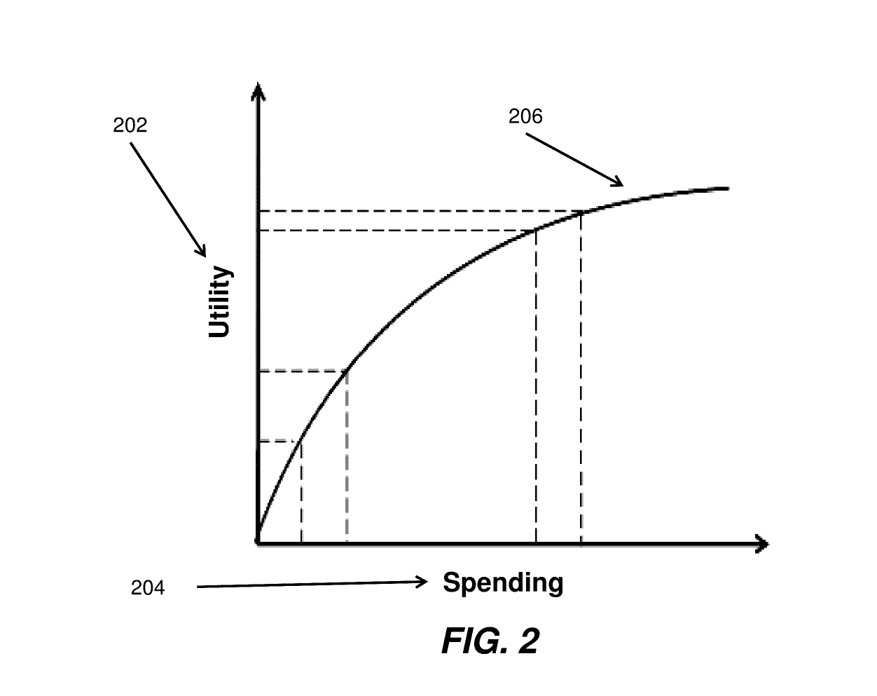

Consumption of healthcare services may be used to gauge a member's health. Consumption data may be obtained from sources including, but not limited to, health care data 102 obtained from health insurance providers, healthcare providers, and directly from members. However, analysis of this consumption takes into account member health conditions. For example, in the case of a member who is a cancer patient or a member with end-stage renal disease, a significant increase in the consumption of heath care services does not necessarily result in a corresponding improvement of that member's health. In such situations, the cost of health care provided to a member may increase as the member's health unavoidably declines as a result of the disease. Additionally, as healthcare consumption increases, there may be a diminishment in the utility provided by that healthcare. This concept is considered when using heath care services consumption as an input to determine a member's heath indicator. This is illustrated in the graph of FIG. 2, which shows the utility 202 (which can be equated to the resultant improvement in member health) compared to medical spending 204. As is shown, the utility curve flattens 206 as spending increases, thus the rate of improvement in health starts to decrease even as greater levels of medical spending take place. As such, in embodiments of the invention, consideration of consumption of healthcare services may be evaluated statistically and consumption values used in the calculation of a heath indicator may be limited to a predetermined standard deviation from a normalized amount for members. Such a limitation may serve to limit the impact of occurrences in which a significant increase in heath care cost does not directly result in a proportional increase in member health.

With regard to consumption of heath care resources, such consumption may be measured by occurrence (in which case consumption is the number of visits or time spend with a healthcare provider) and also by the cost of consumed services. In certain embodiments, the cost of consumed services may be a more readily measurable metric. However, in certain embodiments of the invention, costs associated with prescribed medications may be excluded. This exclusion may lead to increased accuracy of a determined health indicator because, in some circumstances, particularly where members are actively taking their medications, (generally defined as greater than 80% compliance with prescribed instructions), higher pharmacy cost may be a positive factor with regard to a member's health. This result may occur when members are actively managing their condition(s) based upon physician guidance. Thus, compliant members who are managing their conditions may utilize less healthcare services, but have a higher overall cost, while tending towards better health.

In addition to the sometimes inverse relationship between medication cost and a member's health that results from compliance with prescribed treatment, the higher cost of some medications, such as those in the treatment of leukemia, hepatitis C and other viral diseases, blood and kidney disorders, etc., can cost hundreds of thousands of dollars per year for treatment. The initial cost of medications is largely driven by the pharmaceutical industry's research and development efforts to bring a new drug to market, which is on the order of $1 billion. However, over time many drugs are manufactured by generics, which may drastically reduce a members' pharmacy cost for the particular drug. Generally, the brand to generic switch does not change the overall health of a member and thus should not result in a change to a member's health indicator score. Therefore, in certain circumstances, pharmacy cost may excessively influence a cost of care calculation or the cost may vary as the prescribed drug eventually becomes available as a generic.

Therefore, although pharmacy utilization taken solely from a cost perspective may not be a key indicator of a members health in certain embodiments of the invention, other factors such as the members compliance, the number of distinct therapeutic classes of medications prescribed to a member at any one time (where a higher number of concurrently prescribed medications can translate to increased probability to an adverse drug event); or the type of medication a member is prescribed ((for instance, Tylenol 3 ($8.99 from a pharmacy), used for treating mild to moderate pain) compared to Sovaldi® (approximately $84,000 available from Gilead Sciences Inc.) a hepatitis C treatment) may indicate a potential to lower a determined health indicator for a particular member. As such, the number and type of the medications prescribed to a member may be seen to corroborate the severity of the member's diagnosis/condition and comorbidities. As a result, embodiments of the invention may include measures relating the type of medications, number of therapeutic classes, the severity of the medication, possession of the medication, and compliance with the prescribed medication regimen in measuring a members health while removing the pharmacy spend from the objective function.

In order to mitigate the influence of inflation on the determined health indicator, the consumption cost of healthcare services may be adjusted by the consumer price index for Medical Services. Such an index is calculated by the Bureau of Labor Statistics and is averaged over all U.S. cities. Thus, medical costs may be normalized by using Equation 1 or an equivalent to remove the fluctuation in cost of care in order to focus more on the actual medical procedure resulting from a given disease or condition.

Current Medical Cost ($)=(base year cost)*(Current CPI)/(Base year CPI) Equation 1

### Variation Caused by Differences in Physician Fee Schedule

In addition to the impact of general economic inflation on fees for medical services, these fees may also subject to other variation factors. The Centers for Medicaid and Medicare Services (CMS) provides a listing of adjustments for Physician Fee Schedule (PFS) (available from the Centers for Medicare & Medicaid Services, www.cms.gov), which provides Medicare payment information on more than 10,000 services based upon Current Procedural Terminology (CPT) and Healthcare Common Procedure Coding System (HCPCS) code sets. The Physician Fee Schedule allows for adjustments in the cost of healthcare services that physicians provide patients and represent the maximum fees Medicare will pay to physicians on a fee-for-service basis. The CMS breaks down the Physician Fee Schedule to account for Geographic Practice Cost Index (GPCI) allowing for regional adjustments to Physician's Work, Cost for Running the Office and Malpractice Insurance in the form of Relative Value Units (RVU). The use of the Physician Fee Schedule may allow embodiments of the invention to normalize cost utilization across a geographically diverse group of members to account for regional differences. For example, the cost of a procedure such as a hip replacement performed in Manhattan, N.Y. is vastly different than the same procedure performed on a similar individual in Minneapolis, Minn. Despite these differences in cost, the differences in the health of an otherwise similar member requiring these services in the different locations would be minimal after variations caused by community level health data were accounted for.

### Behavioral Health Component

The World Health Organization indicates that “Health is a state of complete physical, mental and social well-being and not merely the absence of disease or infirmity.” In some embodiments of the invention, the incorporation of behavioral health into the consideration of overall health is an important contribution in addition to diagnoses, medical procedures, medications etc. In an embodiment of the invention, a member's perceived health status may be included as a measure in the calculation of a health indicator.

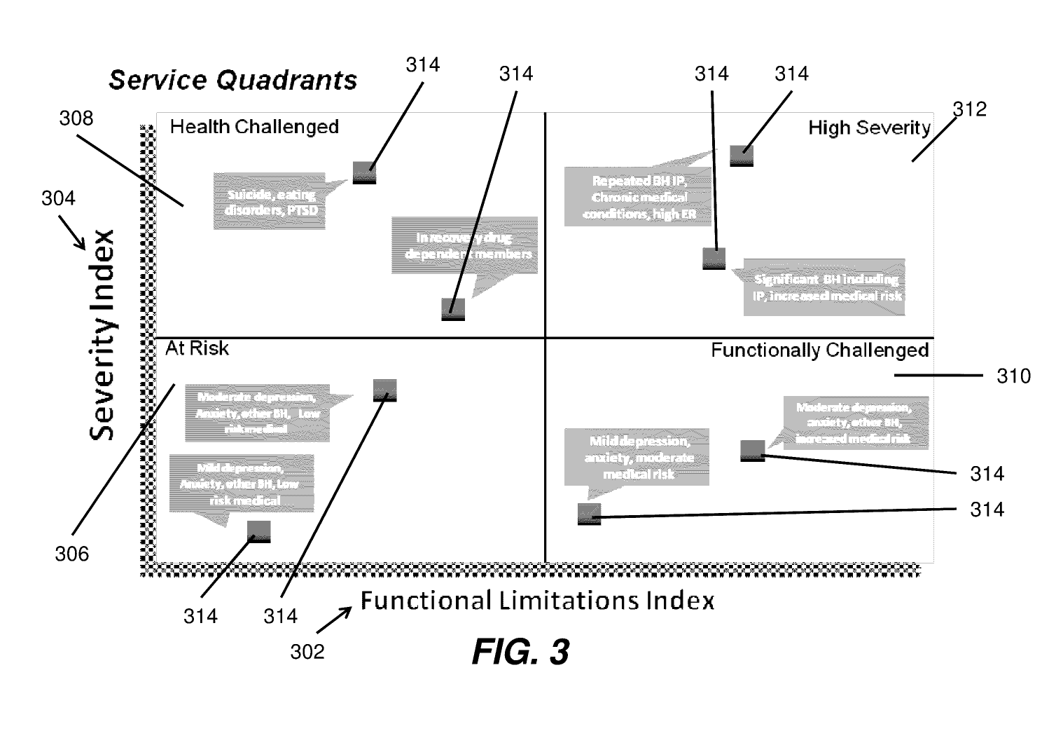

To determine a member's perceived health status in certain embodiments of the invention, members may be interviewed during interactions with service provider personnel to determine the member's perceived health status. In such cases, the use of a common interview may help to standardize the value used for the perceived health status portion of the determined health indicator. Other embodiments of the invention may determine a perceived health status based on the characteristics and severity of medical conditions experienced by a member. Such an embodiment of the invention may use a quadrant assignment methodology to assign a behavioral health indicator to members based on the functional limitations and severity of their conditions. Embodiments of the invention may assign a member to a particular quadrant based on a look-back at medical and prescription claims generated by the member. Various time periods may be used, for example, an embodiment of the invention may look back over nine months of member data to determine a member's assignment to a quadrant. As is illustrated in FIG. 3, members may be assigned to quadrants based on the member's functional limitations 302 and an indexed severity level 304. In an exemplary embodiment, members may be assigned to one of four quadrants. In the example illustrated, those quadrants may be assigned the labels of “At Risk” 306, “Health Challenged” 308, “Functionally Challenged” 310, and “High Severity” 312. The severity and functional limitation indices may range from not at all severe and no functional limitations to maximum severity and functional limitation values that encompass the most severe and most limited member characteristics in a measured member population. As is illustrated in the figure, members 314 may be represented as locations in one of the four quadrants. Those quadrants may then be assigned a behavioral health value based on a member's projected perceived health according to which quadrant they may fall into. In the illustrated example, the “At Risk” quadrant may result in a more favorable perception of health than the “High Severity” quadrant. Thus those members located in the “At Risk” quadrant 306 may have a higher behavioral health value than those located in the “High Severity” quadrant 312. Other embodiments of the invention may use a larger number of divisions (for example, 9 instead of 4) to provide a greater range of variability to the assigned behavioral health values assigned by such a method.

### Accuracy of Newly Added Members

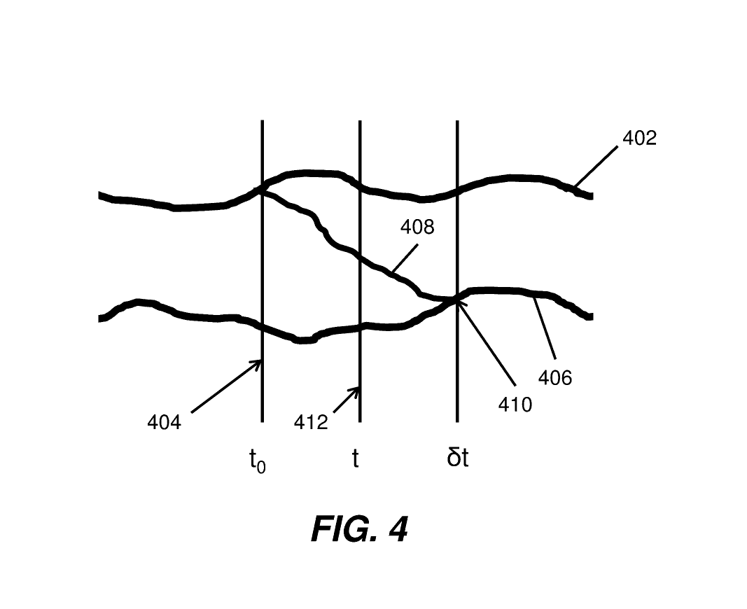

In order to be useful across a variety of members, a determined health indicator score should account for the amount of historical data available with regard to a member. Because there may be little historical information available regarding a new member, newly added members create level of uncertainty with regard to the actual health indicator score that should be assigned to such a member. In an embodiment of the invention, an initial score may be assigned using geographic data and such easily obtainable information as the member's age and sex. As is illustrated in FIG. 4, a member which has been newly added and therefore, one which has little historic data, may have their health indicator score set at the 50^{th} percentile for that member's local area 402 at the time (t₀) 404 when an initial health indicator score is determined for the member. The lack of historic data may be quickly overcome to produce an improved score as the member is engaged in welcome calls, surveys, e-mail, and direct mail campaigns as well when the member engages with health insurance and healthcare providers through annual visits, immunizations and vaccinations, prescription refills, etc. In addition, data may be obtained through a member's participation in health and wellness campaigns and programs offered by health insurance and healthcare providers. In the case of newly added member that has been covered through Medicare from the Centers for Medicare & Medicaid Services, previous years Hierarchical Condition Category (HCC) codes may be obtained and used to provide a basis for calculating an initial health indicator score for the new member. Even in cases where the entity determining the health indicator score for a newly added member does not have a great deal of historical data for a member, commercially available consumer data may be available. Such information may comprise buying behaviors, household income, views on health, etc. as well as county level data such as pollution levels, percent of people who smoke, water quality, access to providers, etc. in the member's local area. As data is accumulated for a new member, that member's health indicator score may approach their actual score 406 (the member's score that would have been determined if historical data was available before time t₀) as is illustrated by the determined member score 408 approaching the point at which the determined score converges with the member's actual score 410. As the score moves from time (t₀) 404, the score may be referred to as an improved score. At any given time (t) 412, the reliability of the member's determined score (represented by R) can be approximated using Equation 2 where t₀ is the time a member information is initially added and an initial determination of that member's health indicator score is determined, t is the time at which the reliability is calculated, and δt is the time at which the member's determined health indicator score converges with their actual health indicator score.

R≈(t−t₀)/δt Equation 2

### Calculating the Health Indicator

In embodiments of the invention, determination of a health indicator score for a member may be performed according to Equation 3.

$$H = {\sum }_{i}^{ } {w}_{i} {M}_{i} = {( {\sum }_{i}^{ } {w}_{i} {M}_{i} )}_{community} + {( {\sum }_{i}^{ } {w}_{i} {M}_{i} )}_{Consumer} + {( {\sum }_{i}^{ } {w}_{i} {M}_{i} )}_{Wellness} {( {\sum }_{i}^{ } {w}_{i} {M}_{i} )}_{Health Data} \qquad Equation 3$$

As is illustrated in the equation, the health indicator (H) is a weighted sum of measures. As is illustrated, measures may be summed from the areas described above including, but not limited to, community data, consumer data, heath insurance and healthcare provider wellness program data, and member health data. As is shown, a weight factor (wᵢ) is used to indicate the correlation between increased health and the particular measure. In embodiments of the invention, this weight factor may be normalized and determined using Equation 4 where the normalized weight for the i^{h} measure is represented by w̅ᵢ. As an example, if there were only one measure, the normalized weight would be 1.0 or 100% of the health indicator score that would be attributed to that particular measure. Thus, the higher the normalized weight attributed to a measure, the more important that measure is to the overall member's heath indicator score.

$$\overline{{w}_{ι}} = \frac{\vert {w}_{i} \vert}{{Σ}_{i} \vert {w}_{i} \vert} \qquad Equation 4$$

Positive weight factors indicate a measure which provides a positive correlation toward increasing health and a negative correlation toward deteriorating health whereas negative weight factors indicate measures which have the opposite effect. For example, a measure related to participation in a health and wellness program may have a positive weight factor, whereas, an indication that a member uses tobacco may have a negative weight factor.

Normalized weights may be aggregated into data areas using Equation 5. As shown, individual normalized weights for county level community data may be summed. In such an embodiment, the sum over all data areas adds up to 100% of the heath indicator score contributions.

$${\overline{w}}_{County} = {\sum }_{i ∈ County}^{ } \overline{{w}_{ι}} \qquad Equation 5$$

As such, the sum of these normalized weights for which data is available will arrive at an overall percentage of that data weighted to its contribution. In this way, if all measures exist, there is 100% of the needed data. The percentage is subsequently decreased, as data is unavailable.

### Measures and Weights

In embodiments of the invention, the measures and weights associated with those measures may be determined using linear and non-linear regression models in addition to more sophisticated techniques such as a Genetic Function Algorithm (GFA) approach that allows those measures most important to the determination of a health indicator to be assigned a greater weight as the member population changes over time. In addition to population changes impacting the weights assigned to measures, the passage of time is also taken into consideration. In embodiments of the invention, a weight applied to a measure may change over time according to the characteristics of the measure. For example, if the measure were related to a reported health condition of the member, that weight may be reduced as the time between the reporting time of the health condition and the time at which a health indicator score for that member is calculated. This reduction in weight may take into account the member's ability to recover from certain reported conditions. Conversely, other conditions may become worse with time, in such an example, the weight may increase with the passage of time.

### Accounting for Data Accuracy

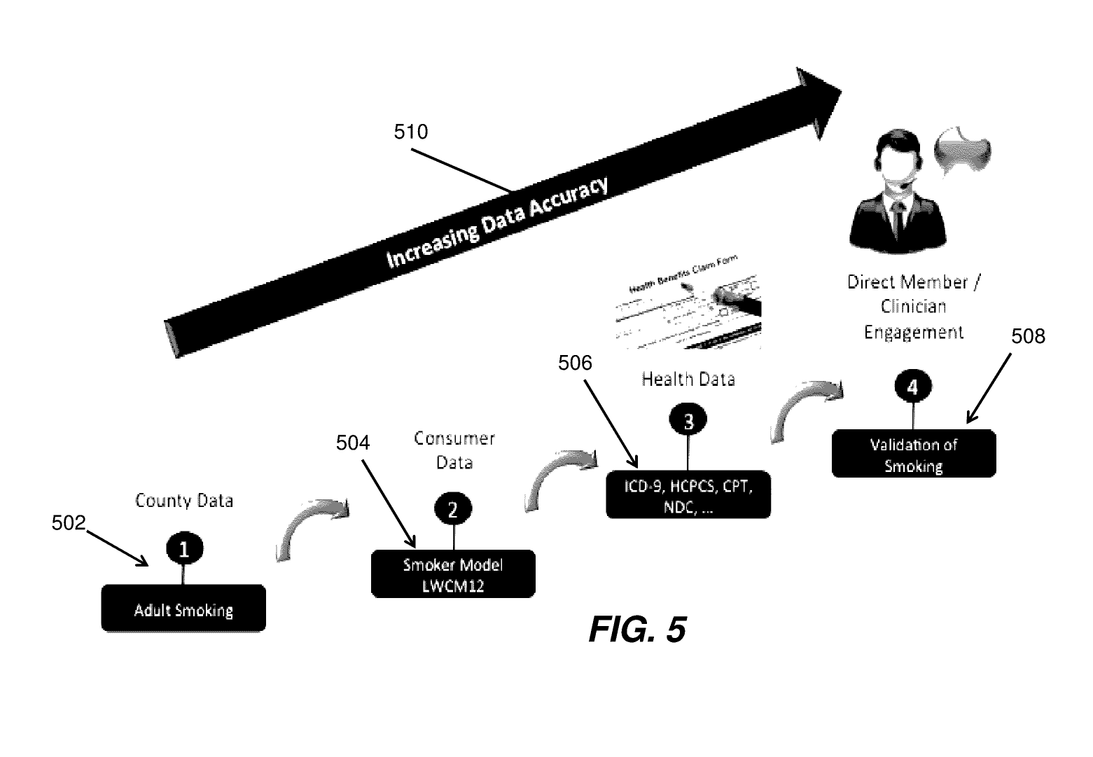

As discussed above, a health indictor score may be comprised from the sum of a series of weighted measures. The weights associated with the measures described have to this point been calculated base on the expected impact that the measure may have on a member's health and thus the member's health indicator score. However, to obtain an accurate health indicator score, the accuracy of the measure data source is taken into account. As an example, the impact of smoking is considered. Referring to FIG. 5, various sources are illustrated from which the negative measure of tobacco use (smoking) may be obtained. The sources may include, but are not limited to, geographic data 502, commercially obtained consumer data 504, health data 506, and direct interaction 508 in the form of interviews between the member and a clinician responsible for obtaining member information. As is illustrated, the accuracy of the measure likely increases as the data source moves from the left to right among the illustrated sources 510. For example, a geographic source that indicates a high percentage of the population are smokers is much less likely to detect that the member is a smoker than would an interview between a clinician and a member during which the member indicates that he or she is regular smoker. Therefore, in embodiments of the invention, an additional factor may be applied to the weighting assigned to a measure where the additional factor may be low for a less accurate source of data and may increase as the data source becomes more accurate.

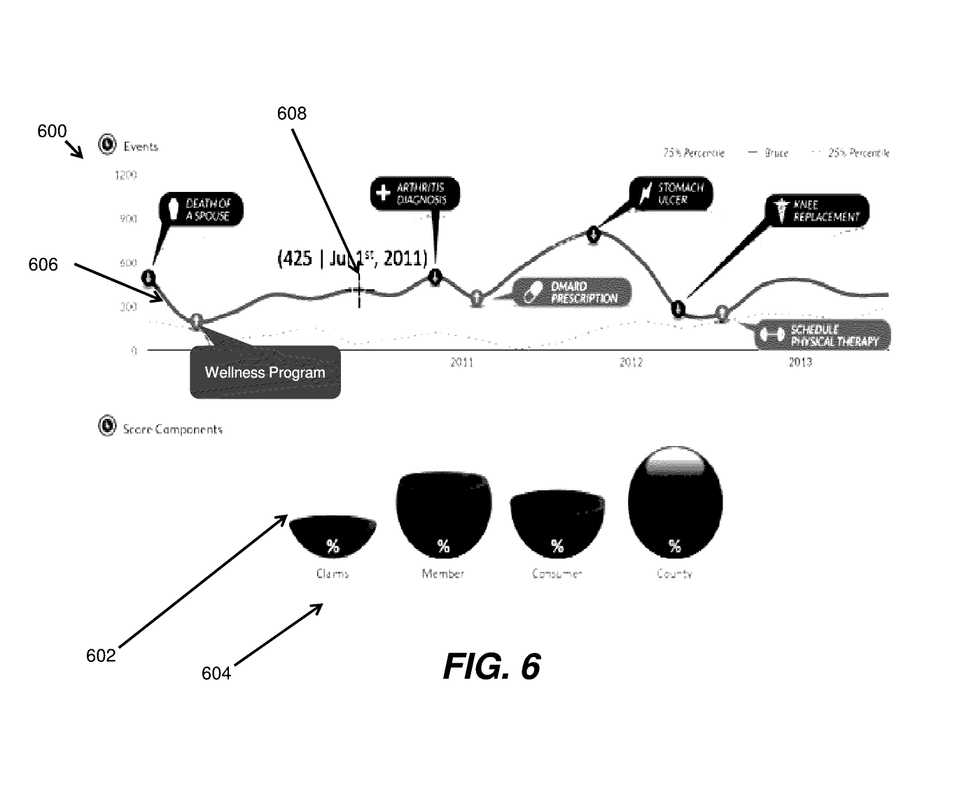

As is illustrated in FIG. 6, in certain embodiments of the invention, a representation of the source measures used to determine a health indicator score may be displayed in a user interface 600 in order to allow a user to determine the source measures used to determine a health indicator score. In the illustrated example, those sources may be illustrated graphically with representations 602 that indicate the sources 604 used to calculate a member health indicator score. As a health indicator score is calculated over a period of time (here represented by the timeline 606) the sources may change as new data sources become available or the time period used to gather those sources excludes sources used for an earlier calculation. In some embodiments of the invention, a user may be provided with the opportunity to select a health indicator score determined at a particular time 608. In such an embodiment, the graphical representations 602 may change the displayed sources represent those sourced used to calculate the indicator score selected by the user.

### User Interface

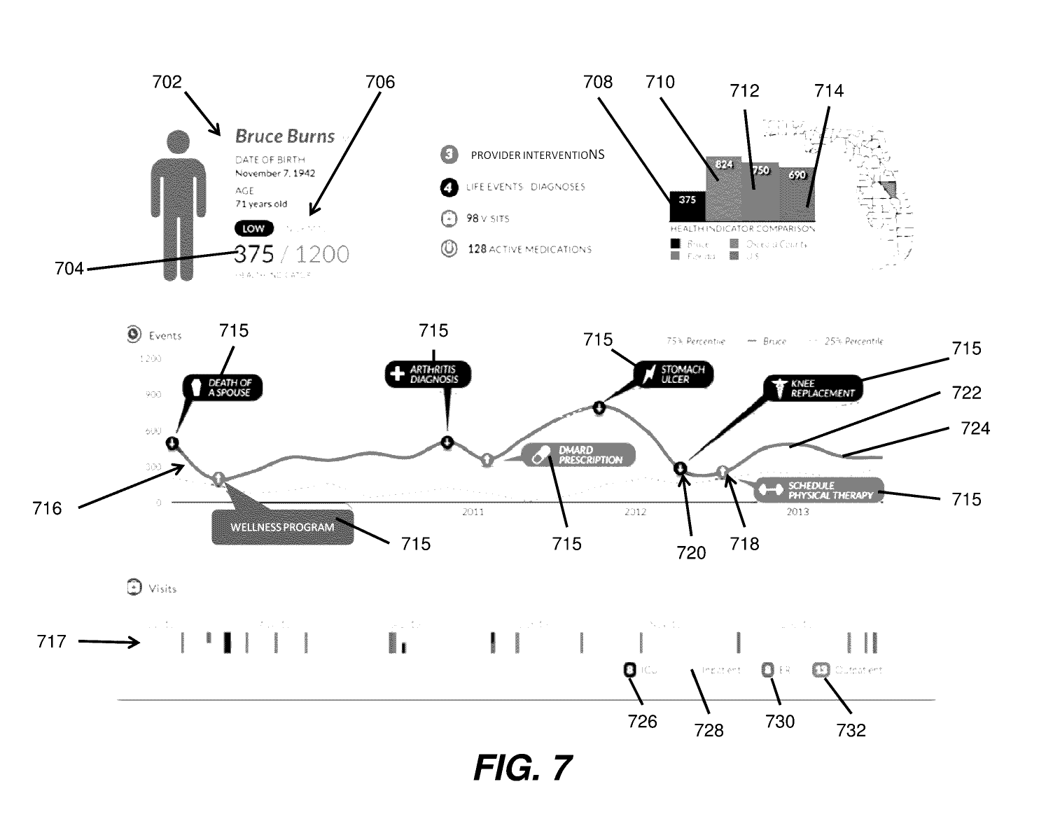

In embodiments of the invention, a user may be less concerned about a member's actual health indicator score value and may instead focus on how the member's score has changed over time or how the member's score compares to other members with similar characteristics. As is illustrated in FIG. 7, in embodiments of the invention, a user interface may comprise member identification information 702 to assist a user in their interaction with a member. An exemplary embodiment of such a display may also comprise a display of the current health indicator score 704. A color coding may be used to quickly indicate whether the member's score is low, normal, or good 706. As was noted above, comparison of a member's score to other member's scores may assist a user of the invention in their interpretation of the member's health status. As illustrated, a geographic comparison may be provided. As shown, the member's score 708 may be displayed alongside of geographic limitations of varying scope (for example, county 710, state 712, and country 714). As is shown, a user may quickly be able to identify that the example member's score is significantly lower than the county in which he lives. In addition to comparison to other member's within a geographic area, an embodiment of the invention may include a timeline of the determined score 716. Such a timeline may assist a user in determining whether there is a trend in the member's score that may indicate a potent problem to be addressed. In addition to the score, the timeline may include key life events. For example, as illustrated in FIG. 7, the death of a spouse, a major surgery, and certain condition diagnoses may be indicated 715 on the timeline 716. In addition to life events, information from the member's medical records may be used to identify key treatments that have been received by the member. These events may provide a user of the invention further indication of what may be impacting a member's health indicator score. Using these indicators as cues, the user may be able to question the member concerning the events or prescribed treatments. For example, in the illustrated example, the member indicated that they were scheduling physical therapy 718 after a knee replacement 720. As is illustrated, the member's health indicator score increased 722 after the physical therapy but then started to decrease to the present level 724. A user of the invention may be prompted to interact with the member to understand what may have caused the decrease and make suggestions to help the member increase their health indicator score. In addition to a timeline 716 of a member's health indicator score, an embodiment of the invention may also comprise an indication of certain measures used to calculate the member's health indicator score. For example, in FIG. 7, a second timeline 717 is illustrated that provides details regarding a member's receipt of medical care services. As is shown, those services may be color coded according to how the treatments were received. For example, Intensive Care (ICU) 726, inpatient care 728, emergency room visits 730, and outpatient care 732.

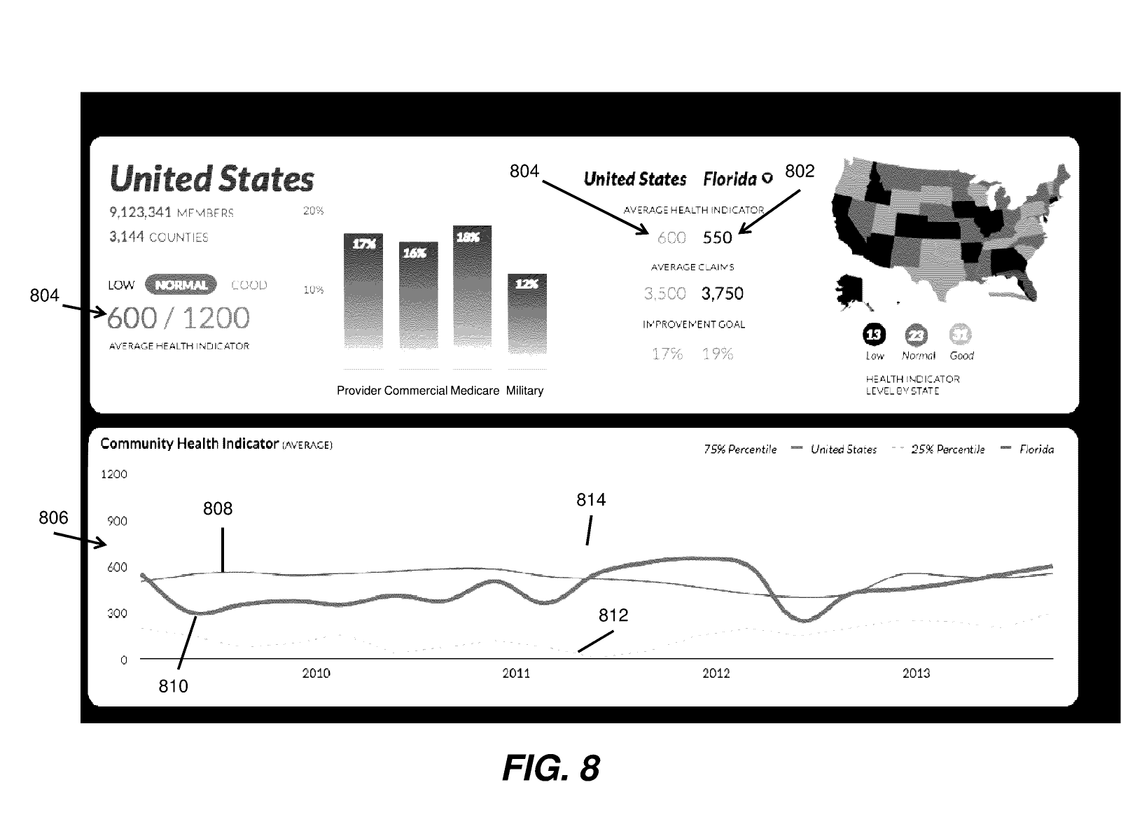

As was noted above, users may wish to compare the health indicator scores of one or more groups. To facilitate such a comparison, a user interface may be configured to display health indicator scores of various group combinations. As is illustrated in FIG. 8, an embodiment of a user interface of the invention may display an average member health indicator for those members in a region (Florida is illustrated) 802 in comparison with an average of another region (in this case, the United States as a whole) 804. Embodiments of the invention may also be configured to present a comparison between similar regions (for example a state being compared with another state) or between a member and a subgroup of members that have similar health characteristics or disease indications. As with the user interface shown in FIG. 7, embodiments of the invention may configure the user interface to include a timeline 806. In the illustrated example, in addition to an indicator for Florida 808 and the United States 810, the timeline graph may also include indications of percentiles along the timeline. For example, the present figure illustrates a 25^{th} 812 and a 75^{th} 814 percentile for points along the timeline.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A computerized method for determining member health indicator scores, comprising the steps of:
(a) receiving at a computer a plurality of public measures for a first member comprising:
(1) at least one consumer behavior measure; and
(2) at least one health measure for a geographic region within which the first member resides;
(b) receiving at the processor a plurality of first weightings, each of the first weightings to be applied to a respective one of the public measures;
(c) applying by the processor the first weightings to the respective public measures;
(d) adding by the processor the weighted received public measures to calculate a health indicator score for the first member; and
(e) displaying at a user device the health indicator score for the member.

2. The computerized method of claim 1, wherein each of the first weightings comprise a factor representing the accuracy of a data source from which the public measure is received.

3. The computerized method of claim 1, wherein the received public measure comprises a representation of the availability and quality of health care within the geographic region.

4. The computerized method of claim 1, comprising the additional steps of:
(f) receiving at the computer a plurality of private health measures for the first member;
(g) receiving at the processor a plurality of second weightings, each of the second weightings to be applied to a respective one of the private health measures;
(h) applying by the processor the first weightings to the respective public measures and the second weightings to the respective private health measures;
(i) adding by the processor the weighted received public measure and private health measures to calculate an improved health indicator score for the first member; and
(j) displaying at a user device the improved health indicator score for the first member.

5. The computerized method of claim 4, wherein each of the first and second weightings comprise a factor representing the accuracy of a data source from which a measure is received.

6. The computerized method of claim 4, wherein private health measures comprise at least one health program participation measure.

7. The computerized method of claim 4, wherein private health measures comprise at least one first member health condition measure.

8. A computerized method for determining member health indicator scores from a combination of public data and private health data, comprising the steps of:
(a) receiving at a computer a plurality of measures for members comprising:
(1) at least one consumer behavior measure;
(2) at least one health measure for a geographic area;
(3) at least one health program participation measure; and
(4) at least one member health condition measure;
(b) receiving at the processor a plurality of weightings, each of the weightings to be applied to a respective one of the measures;
(c) applying by the processor the weightings to the respective measures;
(d) adding by the processor the weighted received measures to calculate a first health indicator score for a preselected member; and
(e) displaying at a user device the first health indicator score for the preselected member.

9. The computerized method of claim 8, wherein the member health condition measure comprises an amount of money spent by the member on health care.

10. The computerized method of claim 9, wherein a factor representing the decreasing utility received in exchange for money spent over a predetermined amount is applied to the data representing the amount of money spent.

11. The computerized method of claim 9, wherein a factor accounting for the variation in healthcare costs across geographic regions is applied to the data representing the amount of money spent.

12. The computerized method of claim 8, wherein the member health condition measure comprises a measure of the preselected member's perception of their health status.

13. The computerized method of claim 12, wherein the preselected member's perception of their health status is determined by interviewing the member.

14. The computerized method of claim 12, wherein the preselected member's perception of their health status is determined by data representing the severity of the member's reported health conditions.

15. The computerized method of claim 8, wherein each of the weightings comprise a factor representing the accuracy of a data source from which the measure is received.

16. The computerized method of claim 8, where the received community measure comprises a representation of the availability and quality of health care within a geographic region within which the preselected member resides.

17. A computerized method for presenting a comparison of selected member health indicator scores with scores from a predetermined geographic area comprising the steps of:
(a) receiving at a computer a plurality of measures for a plurality of members comprising:
(1) at least one consumer behavior measure;
(2) at least one health measure for a geographic area;
(3) at least one health program participation measure; and
(4) at least one member health condition measure;
(b) receiving at the processor a plurality of weightings, each of the weightings to be applied to a respective one of the measures;
(c) applying by the processor the weightings to the respective measures;
(d) adding by the processor the weighted received measures to calculate:
(1) a first health indicator score for at least one selected member of the plurality of members; and
(2) a second health indicator score for members from a predetermined geographic area;
(e) displaying at a user device the first health indicator score for the selected member and the second health indicator score for members from the predetermined geographic area.

18. The computerized method of claim 17 further comprising displaying at the user device for the selected member a timeline of health indicator scores.

19. The computerized method of claim 18, wherein the timeline additionally identifies a plurality of health events for the selected member.

20. The computerized method of claim 17, wherein the received community measure comprises a representation of the availability and quality of health care within the geographic area.
